(19) United States
(12) Patent Application Publication
(10) Pub. No.: US 2008/0056528 A1
(43) Pub. Date: Mar. 6, 2008

(54) Loudspeaker

(75) Inventors: Hiroshi Yano, Mie (JP); Kazuki Honda, Mie (JP); Masahide Sumiyama, Mie (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/575,804

(22) PCT Filed: Jan. 30, 2006
(86) PCT No.: PCT/JP2006/301423

§ 371 Date: Mar. 22, 2007

(30) Foreign Application Priority Data
Feb. 7, 2005 (JP) 2005-030074

(51) Int. Cl. H04R 9/06

(52) U.S. Cl. 381/420

(57) ABSTRACT

In a loudspeaker which includes a frame coupled with a magnetic circuit having a magnetic gap, a diaphragm fixed to the frame at its outer periphery and coupled with a voice coil fitting in the magnetic gap, a pass-through structure is provided for connecting an air space formed between a reverse surface of the diaphragm and an inner side of the voice coil to an outside. Since the pass-through structure makes an air flow route of the air at the reverse-surface side of the diaphragm shorter and reduces aero-flow resistance which affects the diaphragm, the loudspeaker can raise reproducing sound pressure in a low frequency range.

### TECHNICAL FIELD

The present invention relates to a loudspeaker used in various kinds of acoustic apparatuses and information communicating equipment, more specifically, a compact and slim loudspeaker which is suitable for use in a portable telephone or the like.

### BACKGROUND ART

Along with a growing trend for incorporating as much functions in a downsized acoustic apparatus and information communicating equipment, loudspeakers to be used in portable telephones particularly are requested to be more compact in size and more capable of reproducing quality sounds. Even more, loudspeakers for stereophonic sound reproduction are requested.

FIG. 18 is a cross sectional view showing a structure of a conventional loudspeaker of its kind. Magnetic circuit 31 is formed of disc-shape magnet 33 and plate 34 stacked together in the inside of yoke 32 having a shallow canister shape, and provides circular magnetic gap 35.

Frame 36 coupled with magnetic circuit 31 at its center is provided with ventilation opening 36a. Diaphragm 37 is fixed to frame 36 at its outer circumference and coupled with voice coil 38 fitting in magnetic gap 35. Edge portion 37a is provided integrated at the outer circumference of diaphragm 37. The outer circumference of edge portion 37a is fixed to frame 36. In many cases, the diaphragm is made of a resin material. In order to offer a high performance loudspeaker in a compact and slim design, a high energy product rare-earth magnet is used for magnet 33 forming magnetic circuit 31 in the above-configured conventional loudspeaker. A loudspeaker thus structured is disclosed in Japanese Patent Unexamined Publication No. 2003-134585.

In the above-configured conventional loudspeakers, however, flow route of air in a space at the reverse-surface side of diaphragm 37 is blocked by voice coil 38. As a result, the air at the reverse-surface side of diaphragm 37 moves along the following flow route when diaphragm 37 vibrates. Namely, the air travels from the inside towards the outside along voice coil 38 placed in magnetic gap 35, and is finally pushed out to the outside via ventilation opening 36a of frame 36; and it takes the reverse flow course when it is taken in. Thus the air is compelled to move along a lengthy flow route, which means that aero-flow resistance increases, eventually it gives a restriction to the vibration of diaphragm 37. As a result, in the conventional loudspeakers, there has been a problem that the reproducing sound pressure is sometimes suppressed in a low frequency region.

### SUMMARY OF THE INVENTION

The present invention offers a loudspeaker which includes a magnetic circuit having a magnetic gap, a frame coupled with the magnetic circuit, a voice coil which fits in the magnetic gap, a diaphragm which is fixed to the frame at its outer periphery and coupled with the voice coil, and a pass-through structure which connects an air space formed between a reverse surface of a diaphragm and an inner side of a voice coil to an outside.

With the above pass-through structure, a flow route of the air at the reverse-surface side of a diaphragm can be made shorter and the aero-flow resistance of the air, which affects the diaphragm vibration, lower. As a result, the reproducing sound pressure can be raised in a low frequency range.

### BRIEF DESCRIPTION OF THE DRAWINGS

FIG. 1 is a cross sectional view showing a structure of a loudspeaker in accordance with a first exemplary embodiment of the present invention.

FIG. 2 shows a front elevation of a voice coil bobbin at the upper end part, used in the loudspeaker of FIG. 1.

FIG. 3 is a front elevation of the voice coil bobbin of FIG. 2, showing the state where it is connected with a diaphragm at its upper end.

FIG. 4 compares a frequency characteristic of the loudspeaker of FIG. 1 with that of a conventional loudspeaker.

FIG. 5 is a cross sectional view showing a structure of a loudspeaker in accordance with a second exemplary embodiment of the present invention.

FIG. 6A is a plan view of a yoke used in the loudspeaker of FIG. 5.

FIG. 6B shows a cross sectional elevation of the yoke of FIG. 6A.

FIG. 7 compares a frequency characteristic of the loudspeaker of FIG. 5 with that of a conventional loudspeaker.

FIG. 8 is a cross sectional view showing a structure of a loudspeaker in accordance with a third exemplary embodiment of the present invention.

FIG. 9A is a plan view of a yoke used in the loudspeaker of FIG. 8.

FIG. 9B shows a cross sectional elevation of the yoke of FIG. 9A.

FIG. 10 is a cross sectional view showing a structure of a loudspeaker in accordance with a fourth exemplary embodiment of the present invention.

FIG. 11A is a plan view of a yoke used in the loudspeaker of FIG. 10.

FIG. 11B shows a cross sectional elevation of the yoke of FIG. 11A.

FIG. 12 is a cross sectional view showing a structure of a loudspeaker in accordance with a fifth exemplary embodiment of the present invention.

FIG. 13A is a plan view of a plate used in the loudspeaker of FIG. 12.

FIG. 13B is a cross sectional view of the plate of FIG. 13A.

FIG. 14A is a plan view of a magnet used in the loudspeaker of FIG. 12.

FIG. 14B is a cross sectional view of the magnet of FIG. 14A.

FIG. 15 is a cross sectional view showing a structure of a loudspeaker in accordance with a sixth exemplary embodiment of the present invention.

FIG. 16 compares a frequency characteristic of a loudspeaker of FIG. 15 with that of a conventional loudspeaker.

FIG. 17 is a cross sectional view showing a structure of a loudspeaker in accordance with a seventh exemplary embodiment of the present invention.

FIG. 18 is a cross sectional view showing the structure of a conventional loudspeaker.

### REFERENCE MARKS IN THE DRAWINGS

1, 12, 16, 19, 23, 28 Magnetic Circuit

2, 10, 14, 17, 24 Yoke

3, 21, 25 Magnet

4, 20, 26 Plate

5, 11, 15, 18, 22, 27 Magnetic Gap

6 Frame

6a Ventilation Opening

7, 13 Voice Coil

7a, 14a, 17a, 20a, 21a Cut

8, 29 Diaphragm

58a, 29a Edge Portion

9 Adhesive Agent

10a, 24a, 25a, 26a, 29b Through Hole

30 Anti-dust Member

### DETAILED DESCRIPTION OF PREFERRED EMBODIMENTS

Some of the exemplary embodiments of the present invention are described in the following referring to the drawings. The drawings are intended to describe the concept of the present invention, so, they may not represent strict dimensions of constituent components and their relative positioning. Graphs in FIGS. 4, 7 and 16 show frequency characteristics of respective loudspeakers, where lateral axis indicates a frequency, and longitudinal axis indicates a reproducing sound pressure. It is to be noted that these embodiments are exemplary, in no way they should be interpreted as limiting the scope of the present invention.

### First Exemplary Embodiment

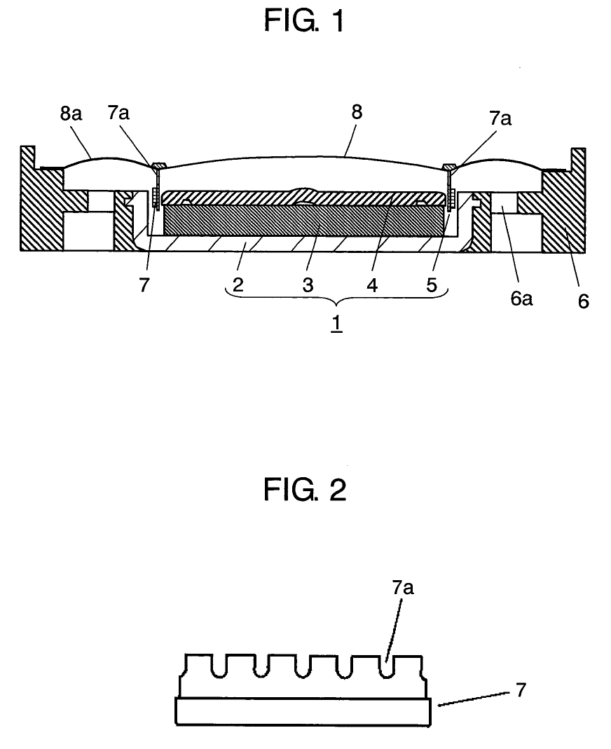

A first embodiment is described with reference to FIGS. 1 through 3.

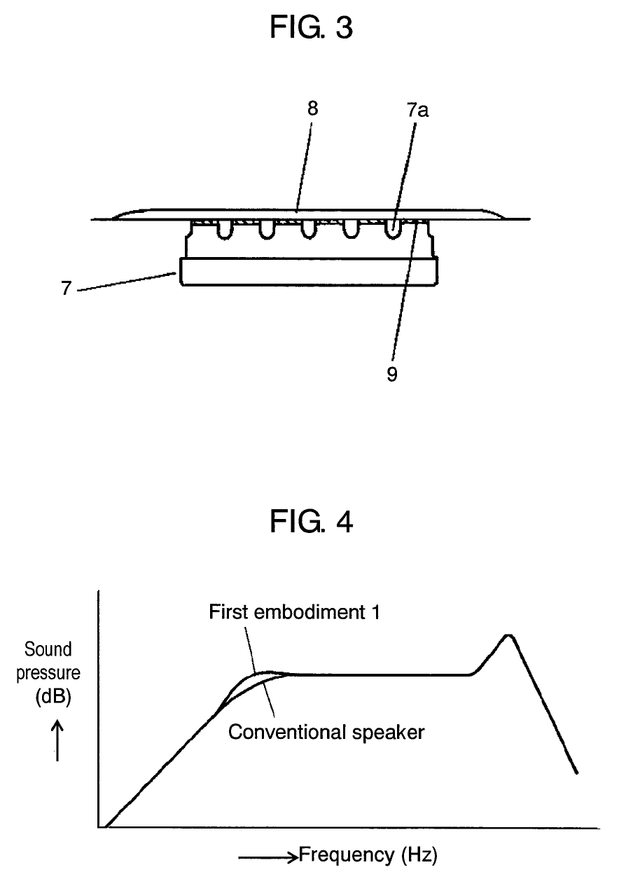

Magnetic circuit 1 is provided as an integration of disc-shape magnet 3 and plate 4 stacked in the inside of yoke 2 having a shallow canister shape. This provides magnetic gap 5 in a circular form. Frame 6 made of a resin material holds magnetic circuit 1 at its center. Frame 6 is provided with ventilation opening 6a. Voice coil 7 is disposed within magnetic gap 5 of magnetic circuit 1 in a free-moving manner. A bobbin forming voice coil 7 is provided with a plurality of cuts 7a at its upper end. Diaphragm 8 is coupled with voice coil 7, and fixed to frame 6 at its outer periphery. Edge portion 8a is provided integrally at a peripheral part of diaphragm 8. Edge portion 8a is fixed to frame 6 at its outer periphery. Voice coil 7 is connected with diaphragm 8 using adhesive agent 9. As shown in FIG. 3, they are connected together so that cut 7a formed at the upper end of the bobbin of voice coil 7 is not clogged by adhesive agent 9.

In a loudspeaker thus provided in accordance with the present embodiment, an air space formed between a reverse surface of diaphragm 8 and an inner side of voice coil 7 is connected to the outside via cut 7a formed at the upper end of the bobbin of voice coil 7. As a result, the air at the reverse surface side of diaphragm 8 can be pushed out or taken into direct via cut 7a when diaphragm 8 vibrates. Since the above-described pass-through structure makes a flow route of the air at the reverse-surface side of diaphragm 8 shorter and reduces the aero-flow resistance which affects diaphragm 8, it can increase the reproducing sound pressure in a low frequency range. FIG. 4 shows frequency characteristics measured with a loudspeaker provided in accordance with the present embodiment and compares it with that of a conventional loudspeaker. As FIG. 4 indicates, a loudspeaker structured in accordance with the present embodiment increases reproducing sound pressure in a low frequency range.

### Second Exemplary Embodiment

A pass-through structure of a loudspeaker in the present embodiment for connecting an air space formed between the reverse surface of a diaphragm and the inner side of voice coil to the outside is different from that of the first embodiment. The rest portions of the loudspeaker remain the same as those of the first embodiment, so that the identical portions are indicated by denoting with the same symbols and detailed descriptions thereof are eliminated. In the following, description is made on the portions different from those of the first embodiment.

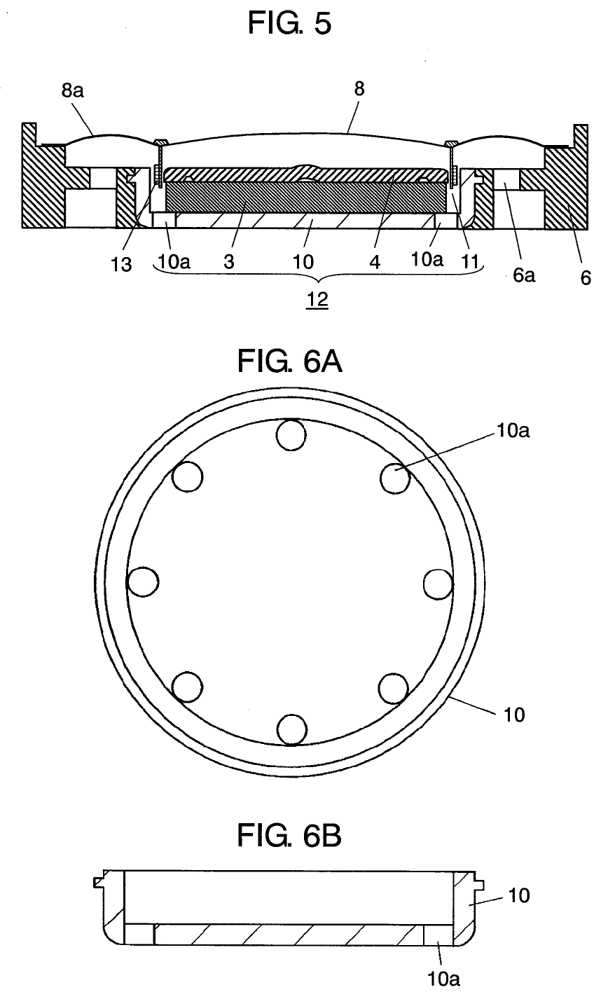

The second embodiment is described hereinafter with reference to FIGS. 5 through 6B. Yoke 10 of a shallow canister form is provided with a plurality of through holes 10a at a periphery of its bottom. Magnetic circuit 12 having circular magnetic gap 11 is provided using the above-described yoke.

In a loudspeaker structured in accordance with the present embodiment, an air space formed between the reverse surface of diaphragm 8 and the inner side of voice coil 13 is connected to the outside via through hole 10a disposed at the periphery of the bottom of yoke 10. As a result, the air at the reverse-surface side of diaphragm 8 can be pushed out or taken into direct via through hole 10a when diaphragm 8 vibrates. Since the above-described pass-through structure makes a flow route of the air at the reverse-surface side of diaphragm 8 shorter and reduces the aero-flow resistance which affects diaphragm 8, it can raise the reproducing sound pressure in a low frequency range.

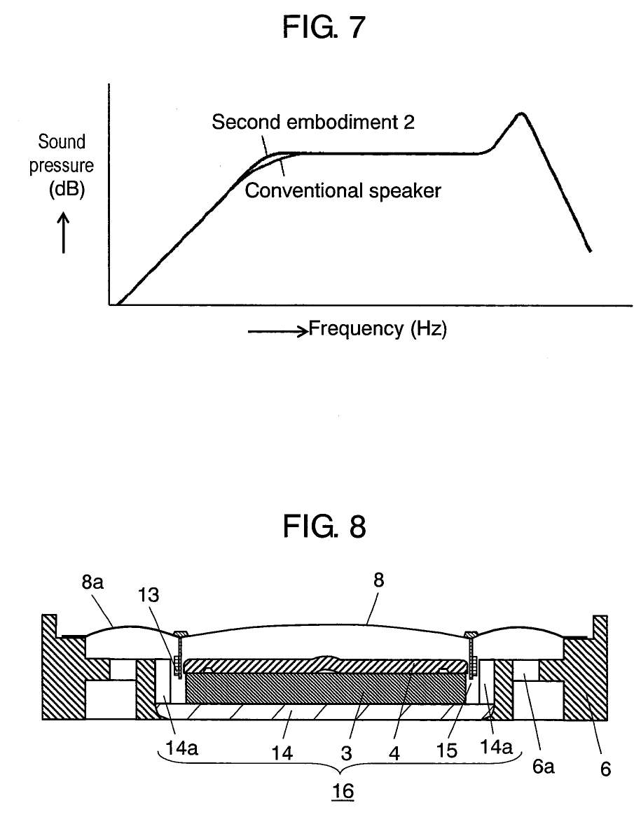

FIG. 7 shows frequency characteristics measured with a loudspeaker provided in accordance with the present embodiment and compares it with that of a conventional loudspeaker. As FIG. 7 indicates, a loudspeaker in accordance with the present embodiment increases reproducing sound pressure in a low frequency range.

### Third Exemplary Embodiment

A pass-through structure of a loudspeaker in the present embodiment for connecting an air space formed between the reverse surface of a diaphragm and the inner side of voice coil to the outside is different from that of the first embodiment. The rest portions of the loudspeaker remain the same as those of the first embodiment, so that the identical portions are indicated by denoting with the same symbols and detailed descriptions thereof are eliminated. In the following, description is made on the portions different from those of the first embodiment.

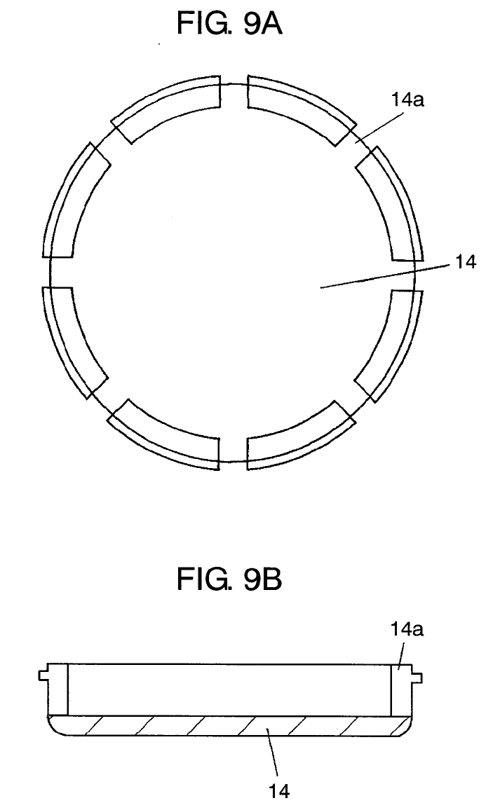

The third embodiment is described hereinafter with reference to FIGS. 8 through 9B. Yoke 14 of a shallow canister form is provided with a plurality of cuts 14a at its side wall. Magnetic circuit 16 having circular magnetic gap 15 is provided using the above-described yoke.

In a loudspeaker structured in accordance with the present embodiment, an air space formed between the reverse surface of diaphragm 8 and the inner side of voice coil 13 is connected to the outside via cut 14a disposed at the side wall of yoke 14. As a result, the air at the reverse-surface side of diaphragm 8 can be pushed out or taken into direct via cut 14a when diaphragm 8 vibrates. Since the above-described pass-through structure makes a flow route of the air at the reverse-surface side of diaphragm 8 shorter and reduces the aero-flow resistance which affects diaphragm 8, it can increase the reproducing sound pressure in a low frequency range.

### Fourth Exemplary Embodiment

A pass-through structure of a loudspeaker in the present embodiment for connecting an air space formed between the reverse surface of a diaphragm and the inner side of voice coil to the outside is different from that of the first embodiment. The rest portions of the loudspeaker remain the same as those of the first embodiment, so that the identical portions are indicated by denoting with the same symbols and detailed descriptions thereof are eliminated. In the following, description is made on the portions different from those of the first embodiment.

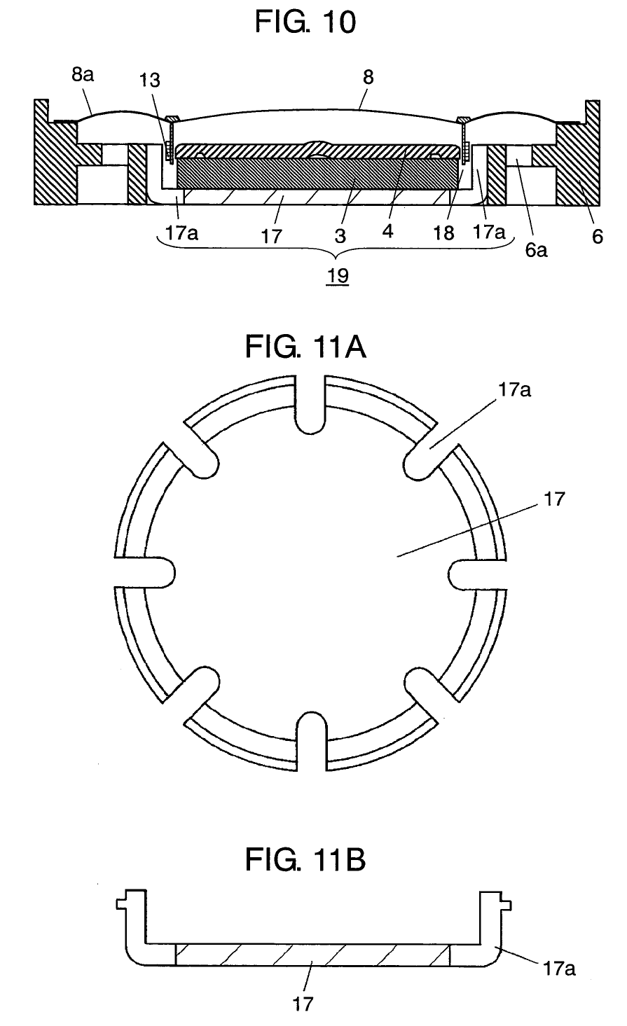

The fourth embodiment is described hereinafter with reference to FIGS. 10 and 11. Yoke 17 of a shallow canister form is provided with a plurality of cuts 17a stretching from a periphery of its bottom to the side wall. Magnetic circuit 19 having circular magnetic gap 18 is provided using the above-described yoke.

In a loudspeaker structured in accordance with the present embodiment, an air space formed between the reverse surface of diaphragm 8 and the inner side of voice coil 13 is connected to the outside via cut 17a disposed stretching from the periphery of the bottom of yoke 17 to the side wall thereof. As a result, the air at the reverse-surface side of diaphragm 8 can be pushed out or taken into direct via cut 17a when diaphragm 8 vibrates. Since the above-described pass-through structure makes a flow route of the air at the reverse-surface side of diaphragm 8 shorter and reduces the aero-flow resistance which affects diaphragm 8, it can increase the reproducing sound pressure in a low frequency range.

### Fifth Exemplary Embodiment

A pass-through structure of a loudspeaker in the present embodiment for connecting an air space formed between the reverse surface of a diaphragm and the inner side of voice coil to the outside is different from that of the first embodiment. The rest portions of the loudspeaker remain the same as those of the first embodiment, so that the identical portions are indicated by denoting with the same symbols and detailed descriptions thereof are eliminated. In the following, description is made on the portions different from those of the first embodiment.

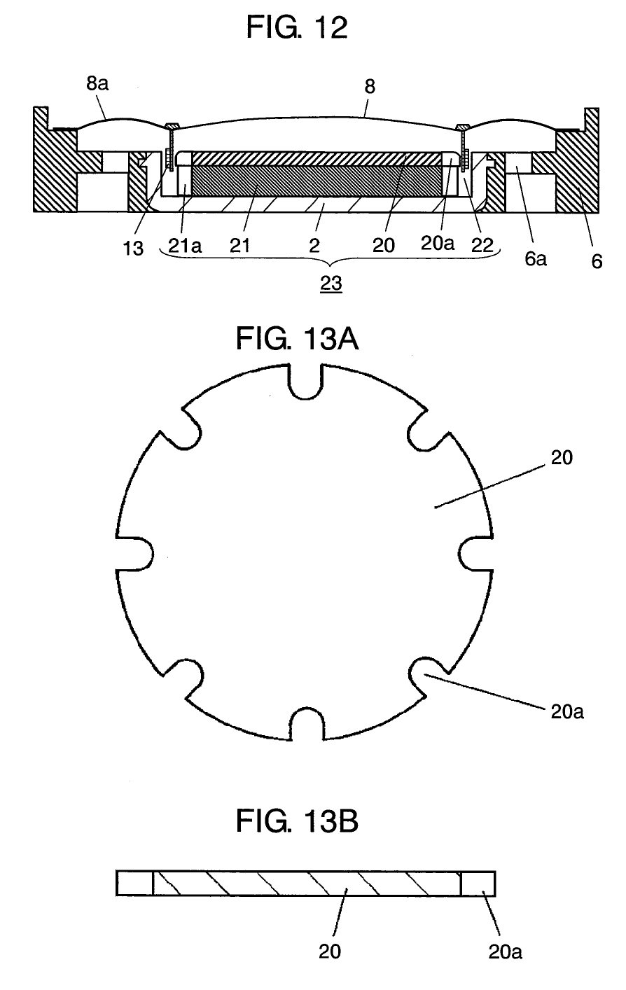

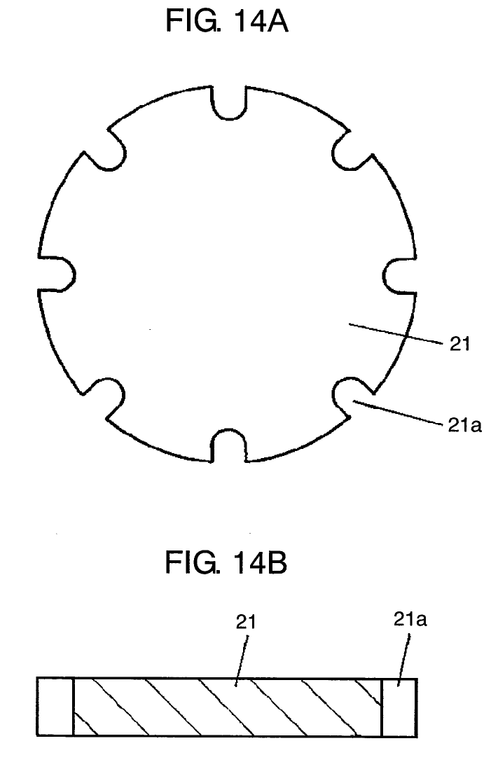

The fifth embodiment is described hereinafter with reference to FIGS. 12 through 14B. Plate 20 and magnet 21 are integrated by stacking them on the bottom of yoke 2 of a shallow canister form. Magnetic circuit 23 having circular magnetic gap 22 is provided in this way. Plate 20 and magnet 21 are provided with a plurality of cuts 20a and 21a respectively at their peripheral edges. When plate 20 and magnet 21 are stacked, cut 20a and cut 21a are integrated to form a single cut.

In a loudspeaker structured in accordance with the present embodiment, an air space formed between the reverse surface of diaphragm 8 and the inner side of voice coil 13 is connected to the outside via cuts 20a and 21a provided at the peripheral edges of plate 20 and magnet 21, respectively. As a result, the air at the reverse-surface side of diaphragm 8 can be pushed out or taken into direct via cuts 20a and 21a when diaphragm 8 vibrates. Since the above-described pass-through structure makes a flow route of the air at the reverse-surface side of diaphragm 8 shorter and reduces the aero-flow resistance which affects diaphragm 8, it can increase the reproducing sound pressure in a low frequency range.

### Sixth Exemplary Embodiment

A pass-through structure of a loudspeaker in the present embodiment for connecting an air space formed between the reverse surface of a diaphragm and the inner side of voice coil to the outside is different from that of the first embodiment. The rest portions of the loudspeaker remain the same as those of the first embodiment, so that the identical portions are indicated by denoting with the same symbols and detailed descriptions thereof are eliminated. In the following, description is made on the portions different from those of the first embodiment.

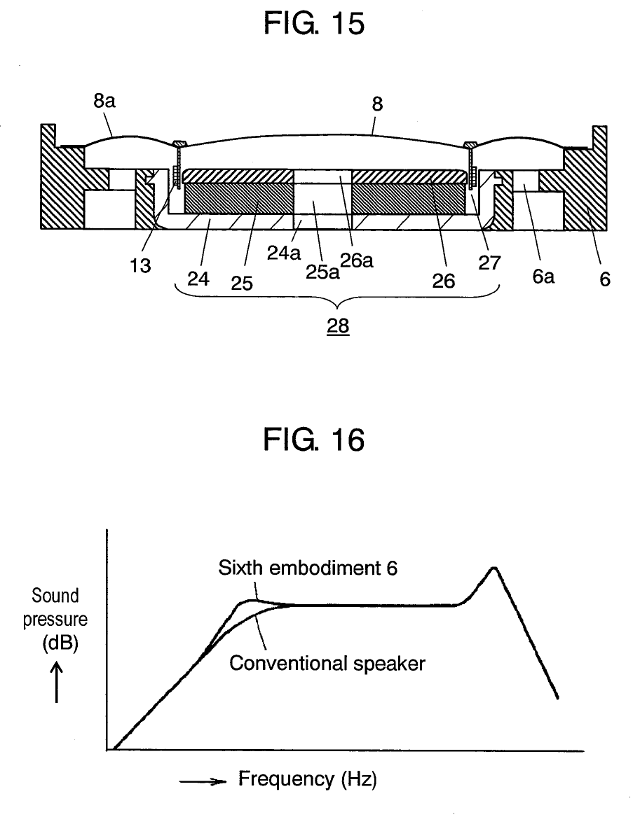

The sixth embodiment is described hereinafter with reference to FIG. 15. Magnet 25 and plate 26 are integrated by stacking them on the bottom of yoke 24 which has a shallow canister form. Magnetic circuit 28 having circular magnetic gap 27 is provided in this way. Yoke 24, magnet 25 and plate 26 are provided with through holes 24a, 25a and 26a at their respective central part. These through holes are coupled together to form a single through hole in the direction of thickness when yoke 24, magnet 25 and plate 26 are stacked integrated.

In a loudspeaker structured in accordance with the present embodiment, an air space formed between the reverse surface of diaphragm 8 and the inner side of voice coil 13 is connected to the outside via the coupled through holes 24a, 25a and 26a provided at the center of yoke 24, magnet 25 and plate 26, respectively. As a result, the air at the reverse-surface side of diaphragm 8 can be pushed out or taken into direct via the coupled through holes 24a, 25a and 26a when diaphragm 8 vibrates. Since the above-described pass-through structure makes a flow route of the air at the reverse-surface side of diaphragm 8 shorter and reduces the aero-flow resistance which affects diaphragm 8, it can increase the reproducing sound pressure in a low frequency range.

FIG. 16 shows frequency characteristics measured with a loudspeaker provided in accordance with the present embodiment and compares it with that of a conventional loudspeaker. As FIG. 16 indicates, a loudspeaker in accordance with the present embodiment increases reproducing sound pressure in a low frequency range.

### Seventh Exemplary Embodiment

A pass-through structure of a loudspeaker in the present embodiment for connecting an air space formed between the reverse surface of a diaphragm and the inner side of voice coil to the outside is different from that of the first embodiment. The rest portions of the loudspeaker remain the same as those of the first embodiment, so that the identical portions are indicated by denoting with the same symbols and detailed descriptions thereof are eliminated. In the following, description is made on the portions different from those of the first embodiment.

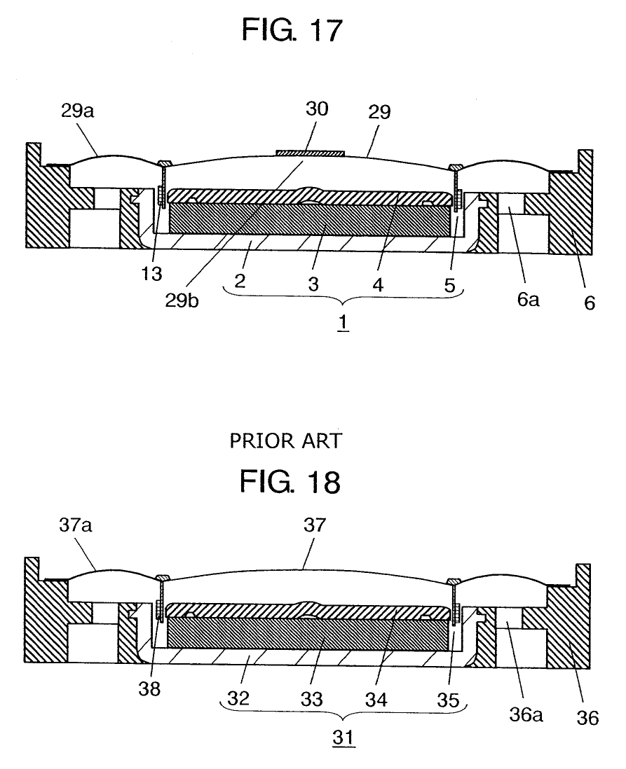

The seventh embodiment is described hereinafter with reference to FIG. 17. Diaphragm 29 is provided with edge portion 29a at its outer periphery. Diaphragm 29 has through hole 29b at its center. Anti-dust member 30 having an air ventilating characteristics is affixed so as to close through hole 29b formed at diaphragm 29.

In a loudspeaker structured in accordance with the present embodiment, an air space formed between the reverse surface of diaphragm 29 and the inner side of voice coil 13 is connected to the outside via through hole 29b provided at the center of diaphragm 29. As a result, the air at the 20 reverse-surface side of diaphragm 29 can be pushed out or taken into direct via through hole 29b when diaphragm 8 vibrates. Since the above-described pass-through structure makes a flow route of the air at the reverse-surface side of diaphragm 29 shorter and reduces aero-flow resistance which affects diaphragm 29, it can increase the reproducing sound pressure in a low frequency range. The size of through hole 29b is determined so that it does not deteriorate characteristics of the diaphragm. A size of approximately 0.5-2 mm, for example, is preferred for through hole 29b. Furthermore, the characteristic in a low frequency range can be optimized by adjusting the ventilation level with anti-dust member 30, namely, by adjusting the aero-flow resistance or acoustic load.

The size and the shape of those cuts to be given to respective members of the loudspeaker may be determined specifically depending on each of the constituent members.

### INDUSTRIAL APPLICABILITY

The present invention offers a loudspeaker in which aero-flow resistance affecting a diaphragm can be lowered by making a flow route of the air at the reverse -surface side of the diaphragm shorter. Thus it can raise the reproducing sound pressure in a low frequency range. The loudspeakers in the present invention are advantageous specifically in loudspeakers for portable telephones, where a high level performance is requested in the limited overall dimensions.

1. A loudspeaker comprising:
a magnetic circuit having a magnetic gap;
a frame coupled with the magnetic circuit;
a voice coil fitting in the magnetic gap;
a diaphragm fixed to the frame at its outer periphery and coupled with the voice coil; and
a pass-through structure for connecting an air space, which is formed between a reverse surface of the diaphragm and an inner side of the voice coil, to an outside.

2. The loudspeaker of claim 1, wherein
the pass-through structure includes a cut at an upper end of a bobbin of the voice coil coupled with the diaphragm.

3. The loudspeaker of claim 1, wherein
the pass-through structure includes a through hole at a periphery of a bottom of a yoke constituting the magnetic circuit.

4. The loudspeaker of claim 1, wherein
the pass-through structure includes a cut at a side wall of a yoke constituting the magnetic circuit.

5. The loudspeaker of claim 1, wherein
the pass-through structure includes a cut stretching from a periphery of a bottom to a side wall of a yoke constituting the magnetic circuit.

6. The loudspeaker of claim 1, wherein
the pass-through structure includes a cut at a peripheral area of a plate and a cut at a peripheral area of a magnet, which constitute the magnetic circuit, and
the cut at the plate and the cut at the magnet have identical shapes.

7. The loudspeaker of claim 1, wherein
the pass-through structure includes a through hole at a plate, a through hole at a magnet and a through hole at a yoke, which constitute the magnetic circuit, and
the through holes are integrated in a direction of a thickness of the loudspeaker.

8. The loudspeaker of claim 1, wherein
the pass-through structure includes a through hole at a center of the diaphragm.

9. The loudspeaker of claim 8, further comprising an anti-dust member having a ventilation characteristic and affixed to the through hole.
